(19) United States
(12) Patent Application Publication
(10) Pub. No.: US 2022/0086562 A1
(43) Pub. Date: Mar. 17, 2022

(54) SPEAKERS WITH MULTIPLE CAVITIES

(71) Applicant: Hewlett-Packard Development Company, L.P., Spring, TX (US)

(72) Inventors: Malcolm Stuart Rix, Chula Vista, CA (US); Jon R. Dory, Spring, TX (US)

(73) Assignee: Hewlett-Packard Development Company, L.P., Spring, TX (US)

(21) Appl. No.: 17/418,891

(22) PCT Filed: Apr. 30, 2019
(86) PCT No.: PCT/US2019/029918

§ 371 Date: Jun. 28, 2021

(51) Int. Cl. H04R 1/28

(52) U.S. Cl. CPC H04R 1/2819; H04R 1/2849; H04N 5/642; H04R 1/2834; H04R 1/2857

(57) ABSTRACT

In an example implementation according to aspects of the present disclosure, a speaker includes an enclosure having a first cavity, a second cavity separate from the first cavity, and a third cavity connecting the first cavity to the second cavity. As an example, a speaker driver is disposed in the first cavity, and a passive radiator disposed in the second cavity.

### BACKGROUND

A speaker, an electroacoustic transducer, converts an electrical audio signal into a corresponding sound. A driver of the speaker, known as the active driver, may include a diaphragm and a voice coil. The diaphragm, sometimes cone-shaped, is a transducer intended to inter-convert mechanical vibrations, for example generated by the voice coil, to sounds. The voice coil, generally a coil of wire attached to the apex of the diaphragm, provides the motive force, or vibrations, to the diaphragm by the reaction of a magnetic field to an electric current passing through the voice coil. In addition to the active driver, additional components may be included in the speaker, for example, to provide further enhancements. As an example of extending the low frequency response of the speaker, bass extender components may be included, such as a bass reflex port or a passive radiator. Compared to active drivers, passive radiator may also include a diaphragm, but may not have a magnet or voice coil. Rather, internal air pressure produced within the enclosure of the speaker, for example, by movements of the diaphragm of the active driver, may move the diaphragm of the passive radiator as well, thereby extending the low frequency response of the speaker.

### BRIEF DESCRIPTION OF THE DRAWINGS

FIG. 1 illustrates a system including speakers arranged under an electronic device, according to an example:

FIG. 2 illustrates a cross-sectional view of the speaker, according to an example; and

FIG. 3 illustrates a rear perspective view of the system including the speakers arranged under the electronic device, according to an example.

### DETAILED DESCRIPTION

Examples disclosed herein provide a speaker with different cavities housing various components of the speaker. As an example, the active driver may be found in a first cavity, while a bass extender component, such as the passive radiator, may be found in a second cavity. In order for the passive radiator to be driven by the active driver, the first and second cavities may be connected to each other by a third cavity, which may have a height lower than either the first or second cavity.

The lower height of the third cavity may afford the opportunity to accommodate an electronic device, such as a computer monitor, in between the first and second cavities of the speaker. As a result, the cavity housing the active driver may be directed towards the user positioned in front of the electronic device, while the cavity housing the passive radiator, which creates omnidirectional sound waves, may be positioned behind the electronic device, away from the view of the user. As the cavity housing the passive radiator is away from a viewpoint of the user, its dimensions may be increased, thereby providing the opportunity to extend the low frequency response of the speaker. By arranging the placement of the components of the speaker as described, particularly exposing the active driver to the user in front of the electronic device, placement of the speaker can vary, according to user preference, as will be further described.

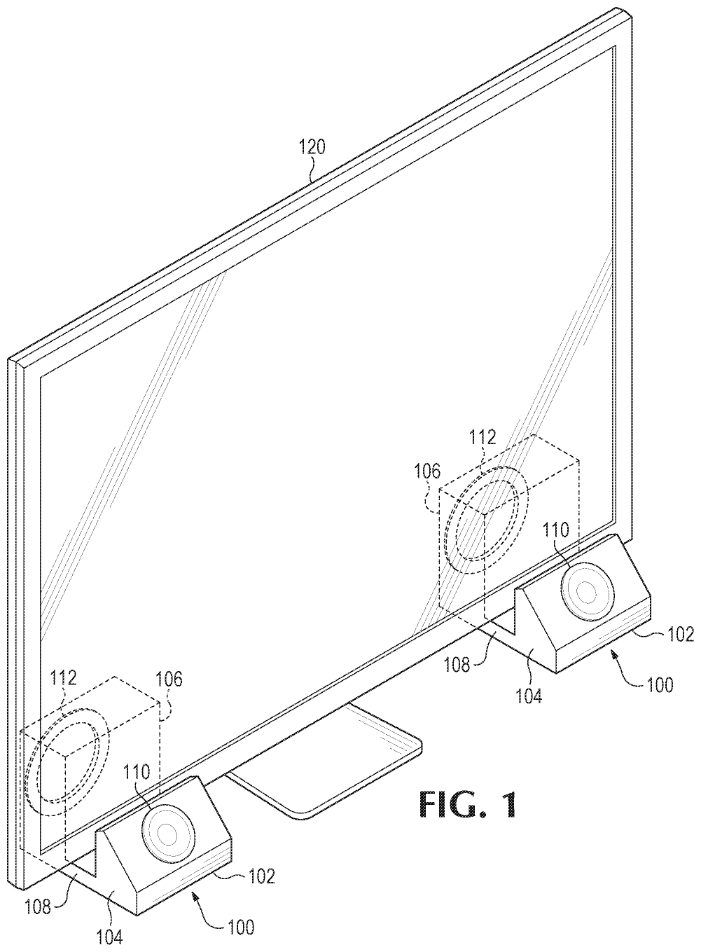

With reference to the figures, FIG. 1 illustrates a system including speakers 100 arranged under an electronic device 120, according to an example. As illustrated, by arranging components of a speaker 100, such as the speaker driver 110 and the passive radiator 112, to be in their own cavities, and joined by another cavity 108 having a lower height, the speaker 100 may be able to accommodate the electronic device 120 in between a first cavity 104 and a second cavity 106. As a result, rather than having to place speakers on either end of the electronic device 120, which may not be ideal for stereo positioning, especially as electronic devices, such as computer monitors, continue to get wider, the unique arrangement provided by speaker 120 allow for them to fit under the electronic device 120, to be placed in their ideal position, or according to user preference. In addition, each speaker 120 may retain high audio performance, as will be further described.

Referring to FIG. 1, each speaker 100 has a sealed, airtight enclosure 102 including a first cavity 104 and second cavity 106, and a third cavity 108 connecting the first cavity 104 to the second cavity 106. The size of each cavity with respect to each other may vary, and are not limited to the dimensions illustrated. For example, the size of each cavity may be taken into consideration for the proper operation of the speaker 100, such as the acoustic coupling between components of the speaker (e.g., speaker driver 110 and passive radiator 112). However, the profile of the third cavity 108 may be low enough and wide enough, for example, to accommodate the electronic device 120 in between the first cavity 104 and second cavity 106. As an example, the height of the third cavity 108 may be lower than the heights of the first cavity 104 and second cavity 106. As an example, the third cavity 108 may include attachment features (not illustrated) to fix the electronic device 120 to the enclosure 102 of the speaker 100. The attachment features may include clamps, or other mechanical features, to secure the electronic device 120.

As an example, a speaker driver 110 may be disposed in the first cavity 104, and a passive radiator 112 may be disposed in the second cavity 106. As an example, the speaker driver 110 may be angled upwards within the first cavity 104, for example, to be directed towards where the user may generally be found. As will be further described, the L-shape passage provided by a combination of the second cavity 106 and third cavity 108 provides a conduit for the internal air pressure produced within the enclosure 102 of the speaker 100, for example, via the speaker driver 110, to move the passive radiator 112 between an in and out position, thereby extending the low frequency response of the speaker 100. As mentioned above, the size of each cavity, for example, the first cavity 104 and second cavity 106, may be taken into consideration for the proper operation of the speaker 100, such as the acoustic coupling between the speaker driver 110 and passive radiator 112. Although a single speaker driver 110 and single passive radiator 112 is illustrated, the number of active drivers and passive radiators may vary. In addition, although a passive radiator 112 is illustrated in the second cavity 106, other bass extender components may be used in its place, such as a bass reflex port.

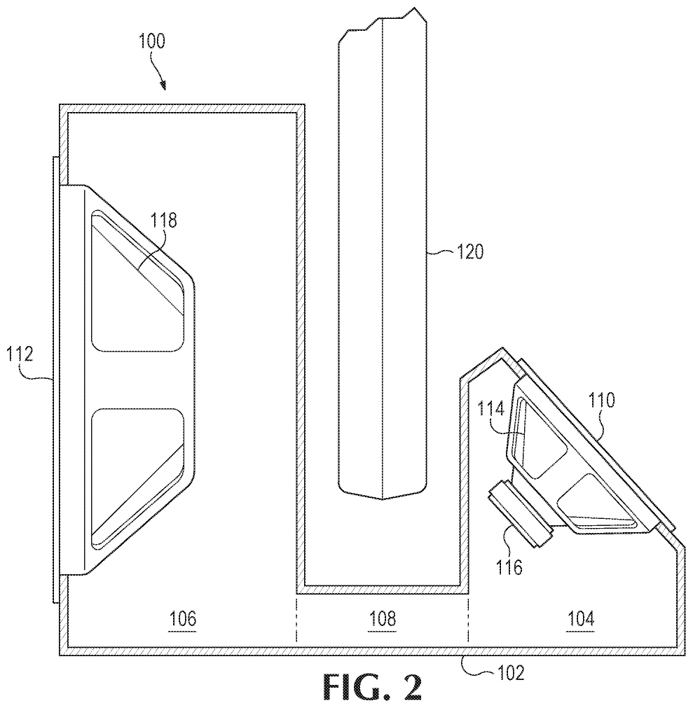

FIG. 2 illustrates a cross-sectional view of speaker 100, according to an example. As illustrated, the first cavity 104 includes the speaker driver 110 and the second cavity 106 includes the passive radiator 112, while the third cavity 108 connects the first cavity 104 and second cavity 106 to each other. Irrespective of the heights of the first cavity 104 and second cavity 106, the lower height of the third cavity 108 allows for the speaker 100 to fit under the electronic device 120, in between the first cavity 104 and second cavity 106. As a result, the first cavity 104 of the speaker 100 may be exposed to a user in front of the electronic device 120, while the second cavity 106 may be hidden from the user.

As the cavity housing the passive radiator 112 is away from a viewpoint of the user, the dimensions of the second cavity 106 and the passive radiator 112 may be increased, thereby providing the opportunity to extend the low frequency response of the speaker 100, possibly reducing the need for a subwoofer. As a result, the volume of the second cavity 106 may be larger than the volume of the first cavity 104, according to an example. As an example, as the first cavity 104 is also not limited by the clearance provided under the electronic device 120, the dimensions of the first cavity 104 and the speaker driver 110 may be increased as well.

Referring to FIG. 2, the speaker driver 110 includes a diaphragm 114, generally cone-shaped, and a voice coil 116 for powering the speaker driver 110. As will be further described, the diaphragm 114 of the speaker driver 110 may move back and forth when an electric current is to be driven through the speaker driver 110. Similarly, the passive radiator 112 may include a diaphragm 118 as well. As described above, the voice coil 116, generally a coil of wire attached to the apex of the diaphragm 114, provides the motive force, or vibrations, to the diaphragm 114 by the reaction of a magnetic field to an electric current passing through the voice coil 116. The diaphragm 114 may then inter-convert the mechanical vibrations to sounds. As the speaker driver 110 may be angled upwards within the first cavity 104 (as illustrated), the sounds may be directed towards where the user may generally be found.

As the enclosure 102 of the speaker 100 may be sealed and airtight, air inside the enclosure 102 may function as a spring. For example, when the diaphragm 114 of the speaker driver 110 moves out, for example, due to the vibrations originating from the electric current passing through the voice coil 116, the air behind the diaphragm 114, within the enclosure 102 of the speaker 100, may experience a partial vacuum, thereby drawing the diaphragm 118 of the passive radiator 112 in, as the diaphragm 118 of the passive radiator 112 moves in response to changing pressures within the enclosure 102. Similarly, when the diaphragm 114 of the speaker driver 110 moves in, the air behind the diaphragm 114, within the enclosure 102 of the speaker, compresses, thereby pushing the diaphragm 118 of the passive radiator 112 out. As a result, the “in and out” motion of the passive radiator 112 may create an omnidirectional sound wave tuned acoustically to enhance the audio performance of the speaker 100, particularly extending the low frequency response of the speaker 100.

This vacuum and compression oscillation may occur in the air cavity of the enclosure 102, particularly the L-shape passage provided by a combination of the second cavity 106 and third cavity 108. The size of the cavities, particularly the first cavity 104 and second cavity 106 may be tuned in order to ensure acoustic coupling between the speaker driver 110 and the passive radiator 112. These two components of the speaker 100 may work in concert to enhance the audio performance, by creating sound waves that add together, effectively enhancing the bass frequencies.

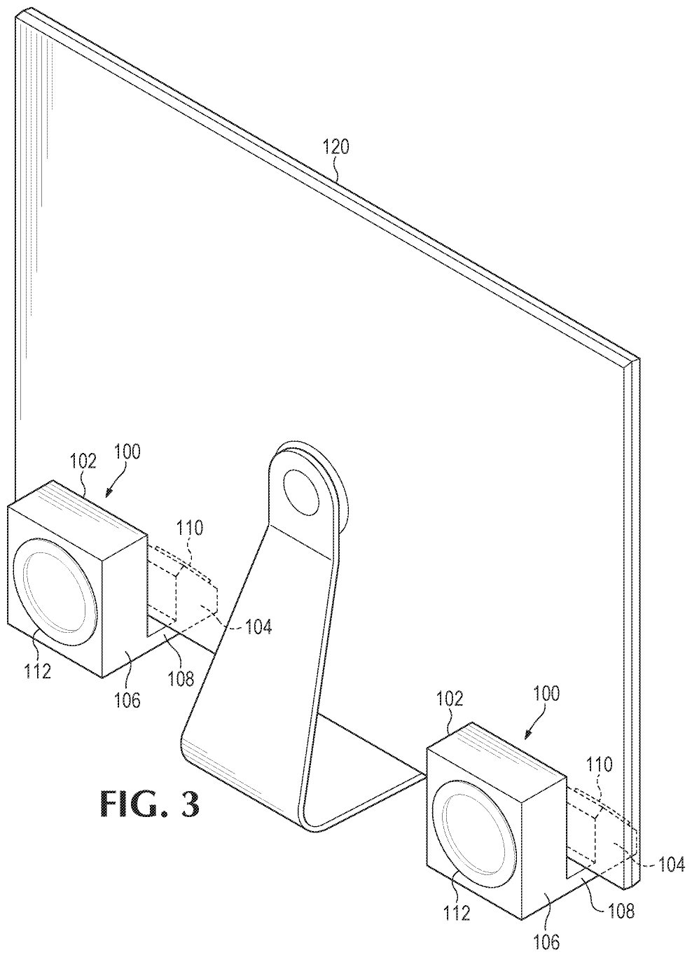

FIG. 3 illustrates a rear perspective view of the system including the speakers 100 arranged under the electronic device 120, according to an example. As illustrated, the second cavity 106, housing the passive radiator 112, may be away from a viewpoint of a user in front of the electronic device 120. As a result, the dimensions of the second cavity 106 and the passive radiator 112 may be increased, thereby providing the opportunity to extend the low frequency response of the speaker 100. As a result, the volume of the second cavity 106 may be larger than the volume of the first cavity 104, according to an example. Although a passive radiator 112 is illustrated in the second cavity 106, other bass extender components may be used in its place, such as a bass reflex port.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A speaker comprising:
an enclosure comprising:
a first cavity;
a second cavity separate from the first cavity; and
a third cavity connecting the first cavity to the second cavity; wherein a height of the third cavity is lower than heights of the first and second cavities;
a speaker driver disposed in the first cavity; and
a passive radiator disposed in the second cavity.

2. The speaker of claim 1, wherein a volume of the second cavity is larger than a volume of the first cavity.

3. The speaker of claim 1, wherein the speaker driver comprises a diaphragm that is to move back and forth when an electric current is to be driven through the speaker driver.

4. The speaker of claim 3, wherein as the diaphragm of the speaker driver is to move back and forth, an internal air pressure is to be produced within the enclosure, to cause corresponding movement of the passive radiator within the second cavity.

5. The speaker of claim 4, wherein a volume of the second cavity is to determine a low-frequency response of the passive radiator.

6. The speaker of claim 1, wherein a width of the third cavity is wide to accommodate an electronic device in between the first and second cavities.

7. The speaker of claim 1, wherein the speaker driver is angled upwards within the first cavity.

8. A system comprising:
an electronic device; and
a speaker comprising:
an enclosure comprising:
a first cavity;
a second cavity separate from the first cavity; and
a third cavity connecting the first cavity to the second cavity, wherein a height of the third cavity is low enough to accommodate the electronic device in between the first and second cavities;
a speaker driver disposed in the first cavity; and
a passive radiator disposed in the second cavity.

9. The system of claim 8, wherein a width of the third cavity is wide to accommodate the electronic device in between the first and second cavities.

10. The system of claim 8, wherein the speaker driver comprises a diaphragm that is to move back and forth when an electric current is to be driven through the speaker driver.

11. The system of claim 10, wherein as the diaphragm of the speaker driver is to move back and forth, an internal air pressure is to be produced within the enclosure, to cause corresponding movement of the passive radiator within the second cavity.

12. The system of claim 11, wherein a volume of the second cavity is to determine a low-frequency response of the passive radiator.

13. A speaker comprising:
an enclosure comprising:
a first cavity;
a second cavity separate from the first cavity; and
a third cavity connecting the first cavity to the second cavity, wherein a height of the third cavity is low enough to accommodate an electronic device in between the first and second cavities;
a speaker driver disposed in the first cavity; and
a passive radiator disposed in the second cavity.

14. The speaker of claim 13, wherein the speaker driver comprises a diaphragm that is to move back and forth when an electric current is to be driven through the speaker driver.

15. The speaker of claim 14, wherein as the diaphragm of the speaker driver is to move back and forth, an internal air pressure is to be produced within the enclosure, to cause corresponding movement of the passive radiator within the second cavity.
